(19) United States
(12) Patent Application Publication
(10) Pub. No.: US 2024/0362841 A1
(43) Pub. Date: Oct. 31, 2024

(54) GAP FILLING OF DATA FOR INFRASTRUCTURE OPTIMIZATION

(71) Applicant: Hyperloop Technologies, Inc., Dubai (AE)

(72) Inventors: Mohammed Ismaeel BABUR, Temple City, CA (US); Yury SOKOLOV, La Mesa, CA (US); Dihan YANG, Alhambra, CA (US)

(21) Appl. No.: 18/645,287

(22) Filed: Apr. 24, 2024

Related U.S. Application Data
(60) Provisional application No. 63/462,931, filed on Apr. 28, 2023.

(51) Int. Cl. G06T 11/40; G06Q 30/0283; G06T 11/20

(52) U.S. Cl. CPC G06T 11/40; G06Q 30/0283; G06T 11/206; G06T 2210/12

(57) ABSTRACT

A method for gap filling of geographic information service (“GIS”) data includes receiving a rasterized cost map including a first alignment curve between two locations. The method also includes determining a pixelization factoring data comprising a pixelization factoring value and pixelization factoring metadata. The method further includes generating a pixelized cost map based on the pixelization factoring data and the rasterized cost map. The method still further includes generating a second alignment curve between the two points in accordance with the pixelized cost map.

### CROSS-REFERENCE TO RELATED APPLICATION

The present application claims the benefit of U.S. Provisional Patent Application No. 63/462,931, filed on Apr. 28, 2023, and titled “GAP FILLING OF DATA FOR INFRASTRUCTURE OPTIMIZATION,” the disclosure of which is expressly incorporated by reference in its entirety.

### BACKGROUND

Geographic information service (“GIS”) data is often used to determine the environment of a linear infrastructure deployment. For instance, a linear infrastructure corridor may be deployed in a mountainous region. As such, the elevation and grade need to be considered when designing the infrastructure for the deployment. GIS data provides such details.

Artificial Intelligence (“AI”) techniques are being used more and more in the design and deployment of infrastructure. For effective application of an AI model, a degree of completeness is specified for the data input to the AI model, such that the AI model may identify an optimized solution for infrastructure arrangement. In most cases, GIS data may be incomplete and/or inaccurate. Moreover, AI faces challenges in interpreting and handling incomplete and/or inaccurate GIS data.

Without improvement to processing GIS data (and other related data), commercial deployment of linear infrastructure may stall. Being a green mode of transportation and part of linear infrastructure, hyperloop has the capability to radically improve the impact that humans have on the environment. Therefore, the stalled deployment of hyperloop will result in continued degradation of the environment. It may be desirable to address input data gaps to optimize infrastructure configurations relating to linear infrastructure deployments via AI models.

### SUMMARY

In some aspects of the present disclosure, a method for gap filling of geographic information service (“GIS”) data includes receiving a rasterized cost map including a first alignment curve between two locations. The method further includes determining a pixelization factoring data comprising a pixelization factoring value and pixelization factoring metadata. The method also includes generating a pixelized cost map based on the pixelization factoring data and the rasterized cost map. The method further includes generating a second alignment curve between the two points in accordance with the pixelized cost map.

Other aspects of the present disclosure are directed to an apparatus. The apparatus includes means for receiving a rasterized cost map including a first alignment curve between two locations. The apparatus further includes means for determining a pixelization factoring data comprising a pixelization factoring value and pixelization factoring metadata. The apparatus also includes means for generating a pixelized cost map based on the pixelization factoring data and the rasterized cost map. The apparatus further includes means for generating a second alignment curve between the two points in accordance with the pixelized cost map.

In other aspects of the present disclosure, a non-transitory computer-readable medium with program code recorded thereon is disclosed. The program code is executed by one or more processors and includes program code to receive a rasterized cost map including a first alignment curve between two locations. The program code further includes program code to determine a pixelization factoring data comprising a pixelization factoring value and pixelization factoring metadata. The program code also includes program code to generate a pixelized cost map based on the pixelization factoring data and the rasterized cost map. The program code further includes program code to generate a second alignment curve between the two points in accordance with the pixelized cost map.

Other aspects of the present disclosure are directed to an apparatus including one or more processors, and one or more memories coupled with the one or more processors and storing processor-executable code that, when executed by the one or more processors, is configured to cause the apparatus to receive a rasterized cost map including a first alignment curve between two locations. Execution of the processor-executable code further causes the apparatus to determine a pixelization factoring data comprising a pixelization factoring value and pixelization factoring metadata. Execution of the processor-executable code also causes the apparatus to generate a pixelized cost map based on the pixelization factoring data and the rasterized cost map. Execution of the processor-executable code further causes the apparatus to generate a second alignment curve between the two points in accordance with the pixelized cost map.

Additional features and advantages of the disclosure will be described below. It should be appreciated by those skilled in the art that this disclosure may be readily utilized as a basis for modifying or designing other structures for carrying out the same purposes of the present disclosure. It should also be realized by those skilled in the art that such equivalent constructions do not depart from the teachings of the disclosure as set forth in the appended claims. The novel features, which are believed to be characteristic of the disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF DRAWINGS

The accompanying drawings, which are incorporated herein and constitute part of this specification, illustrate exemplary aspects of the claims, and together with the general description given above and the detailed description given below, serve to explain the features of the claims.

FIG. 1 is a block diagram illustrating a transportation network.

FIG. 2A is a block diagram illustrating a geographic information system (“GIS”) management system.

FIG. 2B is a block diagram illustrating a cost map data structure and a cost layer data structure.

FIGS. 3A, 3B, 3C, 3D, and 3E are flowcharts illustrating examples of a process for geospatial data gap filling.

FIGS. 4A, 4B, 4C, 4D, 4E, 4F, 4G, 4H, 4I, and 4K are block diagrams illustrating examples of a bounding region.

FIG. 5 is a block diagram illustrating an example computing device suitable for use with the various aspects described.

FIG. 6 is a block diagram illustrating an example server suitable for use with the various aspects described.

FIG. 7 is a flow diagram illustrating an example of a process for gap filling of geographic information service (“GIS”) data, in accordance with various aspects of the present disclosure.

### DETAILED DESCRIPTION

Various aspects will be described in detail with reference to the accompanying drawings. Wherever possible, the same reference numbers will be used throughout the drawings to refer to the same or like parts. References made to particular examples and implementations are for illustrative purposes, and are not intended to limit the scope of the claims.

Costs are generally comprised of more than one underlying cost. For example, acquiring land has a purchase price, which is one component of a cost. Another component of the cost may be costs associated with construction on the acquired land. If the acquired land is difficult to traverse, then construction costs may be high in comparison to similarly priced parcels. In essence, two parcels may be similarly priced but have disparate costs when considered for infrastructure deployment. Therefore, cost evaluation needs to be comprehensive and deep.

Components of a cost are typically represented on two-dimensional (2D) maps. For example, a parcel map may have latitude and longitude coordinates of parcel boundaries. A cost map comprising land values may be overlaid upon the parcel map to observe land values. Further, a cost map comprising construction costs may be overlaid on the land value cost map. Cost layers may be combined in any conceivable order and in any number. In some examples, a particular cost layer may have a higher weight when compared to other cost layers.

When designing a linear infrastructure alignment, a user generally enters input that roughly approximates the alignment of a corridor (or route). The initial alignment may be approximate and sometimes incomplete. However, the initial alignment may be sufficient to enable artificial intelligence (AI) based techniques to optimize the initial alignment. After being optimized, the linear infrastructure alignment may be further utilized as part of the deployment process. However, the input data should be sufficient to allow for an AI model to find optimized solutions within the search space. For ease of explanation, the AI model may also be referred to as a model (e.g., machine learning model).

In some examples, a 2D cost map is generated, wherein the 2D code map includes costs relating to traversing a region of terrain. For example, a single cost may be simple, such as the purchase price of land. Conversely, the cost may be complex and generated based on a number of factors, such as construction costs, environmental costs, regulatory costs, etc. In any case, the 2D cost map is a consolidated representation of the costs such that AI-based optimizers may improve the linear infrastructure configurations.

However, the consolidated costs in the 2D cost map may have gaps that affect the performance of subsequent AI-optimizations. For example, the cost of traversing an existing right-of-way may not be readily determined because the data is missing (e.g., the geographic information service (GIS) data is incomplete for a particular county). Without sufficient input data, the AI may underperform or completely fail when searching for optimized configurations.

Various aspects of the present disclosure address the deficiencies in generated cost maps by use of pixelization techniques. As stated, the costs may be consolidated into a 2D map that may, in some examples, be generated using rasterization techniques. The result of such rasterization is a substantially pixel-perfect representation of the costs. Given that the pixels are essentially units of data arranged in a grid (e.g., 2D array), various aspects leverage techniques deployed on graphical images in order to fill in the gaps of input data. As such, various aspects generate a 2D cost map that is ready for processing by models because the input-data no longer contains gaps that inhibits the successful application of the models.

Particular aspects of the subject matter described in this disclosure can be implemented to realize one or more of the following potential advantages. For example, in some aspects, the described techniques may decrease an amount of time need to deploy to market, increase operating profit, decrease power consumption, optimize land use, increase passenger and/or cargo throughput, protect environmental resources, reduce pollution, reduce reliance on fossil fuels, preserve historical sites, preserve cultural sites, reduce capital costs of infrastructure, increase passenger safety, preserve natural resources, preserve biological resources, reduce noise, increase reliability and maintainability of infrastructure, and the like.

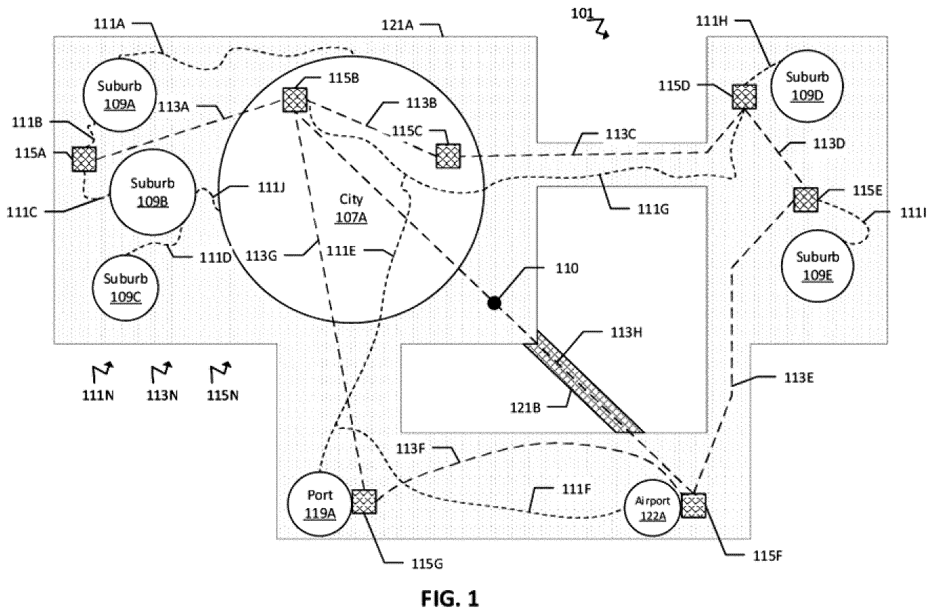

FIG. 1 is a block diagram illustrating a transportation network 101, in accordance with various aspects of the present disclosure. A hyperloop vehicle 110 is shown in the instant view. The transportation network 101 is deployed within a land area 121A. The land area 121A is defined by a number of parameters. For instance, the land area 121A is defined by land that is owned, purchasable, and/or liquid. In some areas of the world, land is unavailable for use as the land may be designated as a nature preserve, in which case no transportation mode may be deployed therein. In another situation, the land may be unavailable for purchase due to competing economic uses (e.g., an industrial company is using the land for extraction of mineral resources). As such, the land outside the shaded land area 121A may be considered unusable by the transportation network 101.

A city 107A is disposed on the land area 121A. The city 107A is considered a large city (e.g., London, Mumbai, etc.). As such, the city 107A is connected by a myriad of transportation modes including rail, automobile, ship, etc. Many cities are surrounded by smaller municipalities or suburbs. For illustrative purposes, the cities and suburbs referred to should generally be considered relative and not exact. For instance, a suburb in China may be considered a large city in Eastern Europe or Australia. One of skill in the art will appreciate that some metropolitan areas are large and some are small.

The land area 121A comprises a first suburb 109A, a second suburb 109B, a third suburb 109C, a fourth suburb 109D, and a fifth suburb 109E. The suburbs 109A, 109B, 109C, 109D, 109E are generally considered metropolitan areas that are smaller in both size and population than a similarly situated city (e.g., the city 107A). In one aspect, the suburbs 109A, 109B, 109C, 109D, 109E may generally be considered single-use areas of land, e.g., a particular suburb may be substantially residential while another suburb may be substantially commercial. On the other hand, the city 107A may be of mixed use where residential, commercial, and industrial use all coexist.

The transportation network 101 comprises a first portal 115A, a second portal 115B, a third portal 115C, a fourth portal 115D, a fifth portal 115E, a sixth portal 115F, and a seventh portal 115G. The portals 115A, 115B, 115C, 115D, 115E, 115F, 115G form a plurality of portals 115N. The plurality of portals 115N includes locations where the hyperloop vehicle 110 may perform a number of actions, including but not limited to: load passengers, unload passengers, load cargo, unload cargo, perform maintenance, remove hyperloop vehicles from service, add hyperloop vehicles to service, change operating personnel, etc. One of skill in the art will appreciate that the plurality of portals 115N may have slightly different functionalities but perform many similar functions. For example, a seaport coupled to a portal may have many of the characteristics of a seaport and a train station, plus the unique aspects of hyperloop (e.g., emission-less vehicles, moving platforms, high speeds, etc.).

The transportation network 101 comprises a port 119A. The port 119A may be generally configured to dock ships at berths, in one aspect. For example, cargo is predominately transported by sea via container-based cargo ships. When cargo ships dock, the cargo containers are unloaded onto dry land. Traditionally, a semi-truck arrives with a trailer to receive and deliver cargo containers.

The transportation network comprises an airport 122A. The airport 122A is generally configured to enable air-based modes of transportation (e.g., airplane, helicopter, etc.). In the instant example, the airport 122A serves the city 107A, the port 119A, and the suburbs 109A, 109B, 109C, 109D, 109E.

The portal 115A is connected to the portal 115B via a route 113A. The route 113A is generally configured to provide an operating environment for the hyperloop vehicle 110. The route 113A, for instance, may be comprised of an elevated series of pylons that support an above-ground tube, e.g., a “hyperstructure.” Within the tube, a near-vacuum pressure environment provides lowered air resistance, thus increasing velocity, energy efficiency, etc. In another aspect, the route 113A may be subterranean and contained within a similar tube as the above-ground example. While the route 113A, and many other similar illustrations, are denoted with substantially straight lines, one of skill in the art will appreciate that natural curves and turns would be present for a hyperstructure in a commercial deployment.

A route 113B connects the portal 115B to the portal 115C. A route 113C connects the portal 115C to the portal 115D. A route 113D connects the portal 115D to the portal 115E. A route 113E connects the portal 115E to the portal 115F. A route 113F connects the portal 115F to the portal 115G. A route 113G connects the portal 115G to the portal 115B. A route 113H connects the portal 115F, near the airport 122A, to the portal 115B.

The route 113H is disposed along a land area 121B. The land area 121B may be considered a congested area of land that has minimal room for additional hyperloop tracks disposed along the route 113H. On the one hand, the route 113H provides substantially direct access between the airport 122A and the city 107A. On the other hand, the route 113H may become quickly overwhelmed by traffic demand, due in part to the narrowness of the land area 121B.

The routes 113A, 113B, 113C, 113D, 113E, 113F, 113G form a plurality of routes 113N having substantially similar characteristics. One of skill in the art will appreciate that the plurality of portals 115N and the plurality of routes 113N are used for illustrative purposes and may have multiple instances within a particular location. For instance, the portal 115A may be comprised of three smaller portals (not shown) that form a discrete transportation network. The plurality of routes 113N may be comprised of hyperstructures that may be subterranean, underwater, on-ground, above-ground, or a combination thereof.

A plurality of roads 111N comprises a first road 111A, a second road 111B, a third road 111C, a fourth road 111D, a fifth road 111E, a sixth road 111F, a seventh road 111G, an eighth road 111H, a ninth road 111I, and a tenth road 111J. The plurality of roads 111N support any existing mode of ground transportation, including, but not limited to, automobile, rail, trolley, subway, bus, or a combination thereof. In modernized cities, high-speed rail may be considered a right-of-way user of the plurality of roads 111N. One of skill in the art will appreciate the plurality of roads 111N is utilized for illustrative purposes and may, in one aspect, simply be the means by which an existing, non-hyperloop vehicle travels.

The road 111A connects the suburb 109A to the city 107A. The road 111B connects the portal 115A to the suburb 109A. The road 111C connects the portal 115A to the suburb 109B. The road 111D connects the suburb 109B to the suburb 109C. The road 111E connects the port 119A to the city 107A. The road 111F connects the airport 122A to the road 111E. The road 111G connects the city 107A to the portal 115D. The road 111H connects the portal 115D to the suburb 109D. The road 111I connects the portal 115E to the suburb 109E. The road 111J connects the city 107A to the suburb 109B.

In one aspect, the suburbs 109A, 109B, 109C, 109D, 109E are connected to the city 107A. In many metropolitan areas, people reside in suburbs and commute to larger city centers. The cities generally have more commercial and industrial opportunities for workers. Stated differently, the land use in the suburbs 109A, 109B, 109C, 109D, 109E may be quite different than that of the city 107A because the suburbs 109A, 109B, 109C, 109D, 109E are primarily residential, and the city 107A is mixed-use. One reason for the difference is simply the land use density. in the city is denser than that of the suburbs.

In one aspect, the hyperloop portal 115A is an example of how the suburbs 109A, 109B may utilize hyperloop. For instance, a worker living in the suburb 109A may take the road 111B to the portal 115A where the worker may park their car in a garage. Then, the worker may use the hyperloop route 113A to arrive at the portal 115B within the city 107A. The worker could then walk to a nearby place of work (e.g., an office complex).

In another example, the hyperloop portal 115E is positioned at the right side of the land area 121A. One of skill in the art will appreciate that most of the suburbs 109A, 109B, 109C, 109D, 109E are connected by the plurality of roads 111N. However, the introduction of the hyperloop portal 115E on the right side of the land area 121A provides an opportunity for land use at and around the hyperloop portal 115E.

The plurality of roads 111N and the plurality of routes 113N form a mesh by redundantly connecting many points within the transportation network 101 (e.g., the suburb 109B has several entries and exits). In contrast, the suburb 109E is only connected by the road 111I. Such a deployment is an example of how a hyperloop portal may encourage growth in an underutilized area of land such as suburb 109E, because suburb 109E is made part of the mesh network by portal 115E. A new, efficient mode of transportation like hyperloop may encourage people in the city 107A to purchase land in the vicinity of the portal 115E in order to avoid congestion, noise, pollution, inadequate schools, crime, etc. However, such an increase in population density may correspondingly increase traffic demand which influences the configuration of new and existing hyperloop routes.

The topology of the transportation network 101 is influenced by a number of factors. For example, the suburb 109E is connected to the road 111I that leads to the portal 115E. One of skill in the art will appreciate how the use of roads to and from the suburb 109E is minimal due to (1) the proximity of the portal 115E and (2) the suburb 109E being built with the portal 115E as a primary mode of transportation for the area. Therefore, the inhabitants of the suburb 109E largely rely on hyperloop for transportation needs when traveling beyond the nearby area of the suburb 109E. As such, the inhabitants of the suburb 109E may rely on fewer transportation modes. In contrast, the inhabitants of the city 107A have multiple points of access to roads and hyperloop routes. Such considerations may affect traffic demand including for example, inhabitants in the suburb 109E may place more demand on the hyperloop routes in the vicinity of the suburb 109E compared to roads in the same area. In short, hyperloop portals need to consider the demographics of the areas serviced in order to configure a hyperloop portal for the deployment environment.

The hyperloop portal 115F is positioned substantially near the airport 122A to illustrate that in some implementations, a portal may be tightly coupled to a nearby location. In the instant example, the airport 122A may unload passengers, near the portal 115F, directly into hyperloop vehicles traveling toward the city 107A. The portal 115G is shown as being tightly coupled to the port 119A. In one aspect, cargo ships docking at the port 119A may unload cargo containers bound for the city 107A. Prior to the introduction of the portal 115G, cargo had to be carried via the road 111E using traditional semi-trucks.

The route 113G connects the portal 115G to the portal 115B. The route 113G may be specially configured to carry cargo-laden hyperloop vehicles that are destined for the city 107A, in one aspect. In another aspect, the hyperloop vehicles traveling along the route 113G may be a mix of passenger-configured and cargo-configured hyperloop vehicles. The route 113F connects the portal 115G to the portal 115F and may be utilized for a combination of passenger and cargo traffic. For instance, passengers may arrive at the airport 122A, enter the portal 115F, travel via the route 113F to the portal 115G, and finally travel along the route 113G to arrive at the portal 115B. In another example, cargo may be offloaded from an airplane at the airport 122A and then be transported to the port 119A via the route 113F. Likewise, the cargo may be transported between the port 119A and the city 107A (or to any other destination).

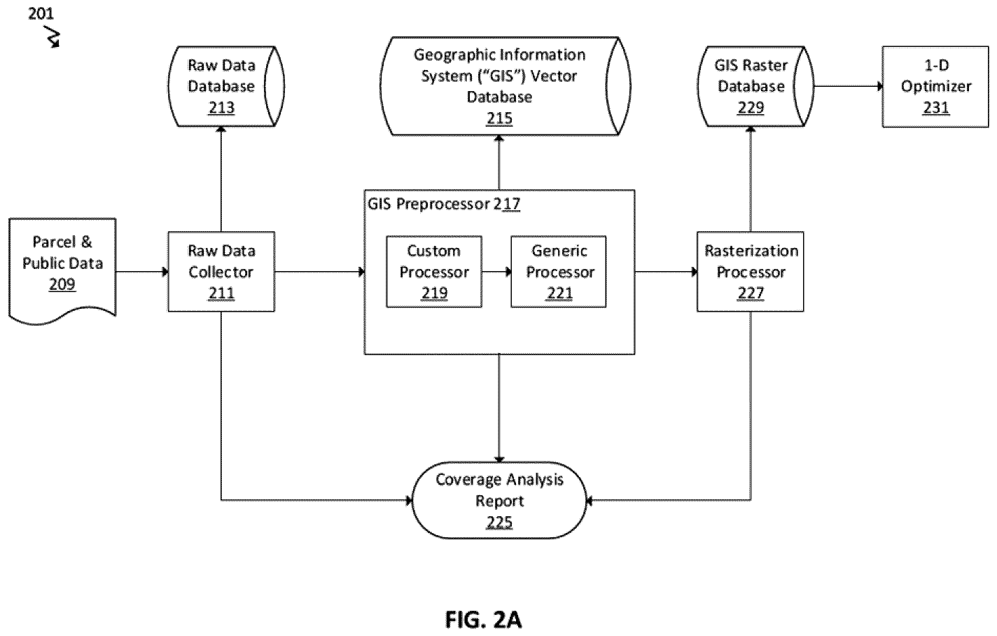

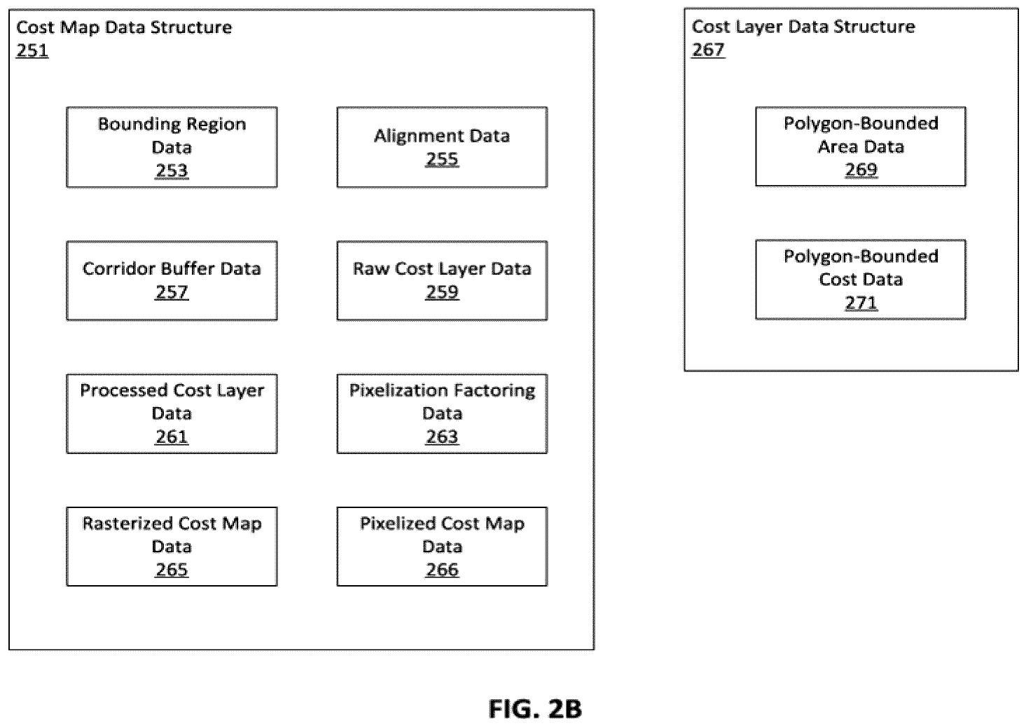

FIG. 2A is a block diagram illustrating a geographic information system (“GIS”) management system 201, in accordance with various aspects of the present disclosure. The GIS management system 201 is generally configured to provide GIS information to a one-dimensional (“1D”) optimizer 231. A coverage analysis report 225 may also be generated by the GIS management system 201 for use by designers, civil engineers, operators, etc.

The 1D optimizer 231 is generally configured to optimize for a single dimension having multiple parameters along a particular alignment. In general, the 1D optimizer 231 may create an optimal design in one dimension, in which that one dimension includes multiple design and configuration parameters. For example, the 1D optimizer 231 may optimize a vertical profile of an alignment to reduce capital expenditure costs that are necessary to deploy a hyperloop route (e.g., the route 115A). The 1D optimizer 231 also accounts for vehicle acceleration limits, passenger acceleration limits, jerk limits, grade constraints (e.g., gradeability), motor acceleration, motor power capabilities, braking capabilities, thermal limits, etc. The 1D optimizer 231 may also consider parameters from other dimensions to understand some three-dimensional constraints.

The 1D optimizer 231 may rely on local multivariate optimization for a piecewise continuous spline with non-linear constraints using a Broyden-Fletch-Goldfarb-Shanno (“BFGS”) function and/or a Sequential Least Squares Programming (“SLSQP”) function. Optimization types for entities with multi-order continuity at the boundaries may include a genetic algorithm and/or a particle swarm algorithm. Depending on the context, one of skill in the art will appreciate that one or both functions may be utilized.

The 1D optimizer 231 is further configured to be utilized during trip simulations such that kinematic-related optimizations may be tested. For example, peak velocity may be selected as the trajectory (or drive strategy) to optimize; the trip simulation may then utilize and validate the 1D optimization of kinematics related to the hyperloop vehicle 110 during operation. Likewise, the trip simulation may inform the 1D optimizer 231 of any deficiencies discovered during the simulation, and/or be used to understand the full kinematic constraints to be considered for the 1D optimizer 231 to further optimize an alignment and profile.

The GIS management system 201 is configured to receive parcel, public data 209 and/or uploaded private data (not shown). The parcel and public data 209 and/or uploaded private data may be parcel maps of land areas. In one aspect, the parcel maps may be augmented with prices indicating the value of the land (as well as any improvements thereto). The value of land may be considered by the 1D optimizer 231 when optimizing an alignment and profile. In one aspect, the parcel and public data 209 and/or uploaded private data may be any public data relating to land value, land use, land prices, property taxes, ownership, encumbrances, historical status, environmental protection status, topography, utilities, geology, water bodies, vegetation, or maps based on certain analyses including flood maps, seismic risk maps or the like. Such information may be utilized by the 1D optimizer 231 in order to generate optimized alignments and potential profiles.

A raw data collector 211 is generally configured to configure and store data of various types and formats. One of skill in the art will appreciate that GIS data may be received in many different formats. For example, GIS data may be received as vectorized data or rasterized data. The raw data collector 211 processes disparate types of data. One of skill in the art will appreciate that such a benefit provides users with ease of use because various types of data may be aggregated and processed such that the user is free to focus on designing the linear infrastructure route.

A raw data database 213 is generally accessible by the raw data collector 211 in order to write or read raw GIS data. The raw data collector 211 is configured to output the raw GIS data to the coverage analysis report 225, such that a consumer of the coverage analysis report 225 may access the raw GIS data supporting other processed outputs (e.g., rasterizations). The coverage analysis report 225 contains the details of what factors and objectives were considered when determining an alignment and profile. For example, a hyperloop route (a form of linear infrastructure) may be optimized such that the hyperloop route traverses a plot of land. During eminent domain proceedings, the coverage analysis report 225 provides a detailed and objective source of information to support or refute an eminent domain claim.

The coverage analysis report 225 may be regenerated based on considerations uncovered as part of new events. For example, the coverage analysis report 225 may be regenerated during an eminent domain proceeding in order to arrive at a more optimized solution for stakeholders involved in the eminent domain proceedings. One of skill in the art will appreciate that the disclosed solution may arrive at the same optimization in many cases; nevertheless, the coverage analysis report 225 provides a critical source of information as to what data was considered when arriving at said same optimization.

A GIS preprocessor 217 comprises a custom processor 219 and a generic processor 221. The GIS preprocessor 217 is generally configured to preprocess the raw GIS data sent by the raw data collector 211. The raw GIS data may thereafter be considered preprocessed GIS data. The preprocessed GIS data may be written to the coverage analysis report 225 or to a GIS vector database 215. The GIS vector database 215 is accessible by the GIS preprocessor 217 in order to write or read preprocessed the vectorized data.

The custom processor 219 is generally configured to address situations where the cost of traversing a particular GIS data layer is unknown (or unsatisfactory for optimization). The GIS data layer may be manipulated such that a cost function may be derived for an optimization. For example, a GIS data layer for terrain may include only raw elevation data; the custom processor 219 may use the raw elevation data to generate a meaningful cost metric, such as a slope raster in order to have a slope cost function. As another example, a body of water represented in a GIS data layer may not have a cost function associated with crossing the body of water. Likewise, the custom processor 219 generates a cost function based on traversing the body of water via a tunnel or bridge. The output of the custom processor 219 is then communicated to the generic processor 221 for further operations (e.g., normalization).

The generic processor 221 is generally configured to normalize any cost functions in the GIS data layer. Often, the GIS data layer contains the necessary cost functions. For example, a terrain map may have associated therewith the prices of land. However, even with a cost function present, the GIS data layer may still need further normalization and processing prior to consumption by additional AI algorithms, systems, modules, etc.

A rasterization processor 227 is generally configured to receive the preprocessed GIS data from the GIS preprocessor 217. The rasterization processor 227 is configured to rasterize any data into an aggregated image with multiple raster bands. For example, the GIS data received from the GIS preprocessor 217 may be vectorized data. As such, the rasterization processor 227 may rasterize the vectorized data into a single image with multiple raster bands. Each raster band may be further placed in a data structure, such as a tree or other structure, based on the various resolutions of the raster bands (or entire image itself), thus providing a user with the capability to explore the data in an efficient and responsive manner. The rasterization processor 227 is configured to output the rasterized GIS data to a GIS raster database 229. In one aspect, the GIS raster database 229 then communicates the rasterized GIS data to the 1D optimizer 231.

FIG. 2B is a block diagram illustrating a cost map data structure 251 and a cost layer data structure 267, in accordance with various aspects of the present disclosure. The cost map data structure 251 comprises bounding region data 253, alignment data 255, corridor buffer data 257, raw cost layer data 259, processed cost layer data 261, pixelization factoring data 263, rasterized cost map data 265, and pixelized cost map data 266. The cost layer data structure 267 comprises polygon-bounded area data 269 and polygon-bounded cost data 271.

The cost map data structure 251 is generally configured to encapsulate data relating to the 2D cost maps as well as metadata related thereto. The bounding region data 253 is generally configured to define a 2D array that represents the search space as well as physical space beyond the search space. For example, a bounding region may be defined as an entire municipality in which an alignment is to be deployed. In one aspect, the 2D grid is defined by latitude and longitude coordinates forming a bounding box.

The alignment data 255 is generally configured to represent one or more curves forming the alignment of a linear infrastructure corridor. The alignment data 255 is further configured to store additional metadata. For example, the alignment data 255 may comprise data that mathematically relates the curves to one another. For example, a first curve may be designed between the portals 115A, 115B, and a second curve may be designed between the portal 115B and the portal 115C—in which case the alignment data 255 stores the relationship between the first curve and the second curve in order to form a continuous alignment between the portals 115A, 115C.

In one aspect, the alignment data 255 may be initialized with an initial alignment in order to start subsequent operations relating to search space optimization. For example, initial alignment data may include a simple alignment within the bounding region. The simple alignment may be utilized to generate a corridor buffer that comprises the extents of the actual search space of the 1D optimizer 231.

One of skill in the art will appreciate that the alignment is distinct from the profile. For the purposes of the disclosed solution, the alignment is of keen interest because the alignment generally defines where the profile will be deployed. In other words, the profile is generally configured to be overlaid on the ultimate alignment placement. Thus, the alignment data 255 may be updated and augmented to include additional data relating the alignment data 255 to any profile data (not shown). In one aspect, the alignment data 255 is augmented by the 1D optimizer 231 such that profile data may readily be associated with the alignment data 255.

The corridor buffer data 257 is generally configured to define a corridor at or near the initial alignment, as stored in the alignment data 255. As stated, the alignment data 255 may comprise initial alignment data within the bounding region data 253. The bounding region data 253 generally relates to the larger extent of the search space and the corridor buffer data 257 is the more relevant areas of the search space. As such, the 1D optimizer 231 is more efficient when determining optimized alignments (and even profiles). Thus, the initial alignment data forms the basis for corridor buffer data 257.

The raw cost layer data 259 is generally configured to store one or more layers containing cost-related data. For example, a parcel map may be included in a layer of the raw cost layer data 259 in order to demarcate the boundaries of various land parcels. Further, a land value map may be included as yet another layer of the raw cost layer data 259. As such, the cost map data structure 251 contains data sufficient to generate processed cost layer data 261, which is generally configured to provide the 1D optimizer 231 the data for alignment optimization.

The processed cost layer data 261 is generally configured to store the raw cost layer data 259 after having been processed by the GIS management system 201 (and related processes). As stated, the 1D optimizer 231 is configured to perform advanced search and AI techniques on the processed cost layer data 261 in order to optimize the alignment data 255 further.

The pixelization factoring data 263 is generally configured to store data relating to pixelization techniques used to fill in gaps in the raw cost layer data 259 and/or the processed cost layer data 261. Thus, the pixelization factoring data 263 is such that pixelization operations may be controlled, managed, observed, optimized, etc.

The rasterized cost map data 265 is generally configured to provide a 2D array of data that represents the processed cost layer data 261. The rasterized cost map data 265 may be represented as a bitmap, in one aspect. Having the data represented in such a 2D array provides consolidated data that the 1D optimizer 231 may utilize to optimize the alignment data 255.

The pixelized cost map data 266 is generally configured to provide a 2D array of data that represents the processed cost layer data 261. One of skill in the art will appreciate that the rasterized cost map data 265 may have data gaps. In contrast, the pixelized cost map data 266 is configured to address any data gaps in the 2D array of the rasterized cost map data 265.

The cost layer data structure 267 is generally configured to store data relating to a real-world location. In general, the boundaries of the real-world locations are stored as polygons in the cost layer data structure 267. In one aspect, the raw cost layer data 259 and the processed cost layer data 261 utilize several cost layer data structures 267 in order to generate an optimized search space for consumption by the 1D optimizer 231. In general, the cost layer data structure 267 instances will be represented in the resulting rasterized cost map data 265.

The polygon-bounded area data 269 is generally configured to store a plurality of coordinates, lines, vectors, rays, etc., any of which form a polygon-bounded region related to the real-world deployment of an alignment. For example, a polygon-bounded area may be a parcel of land that is available for purchase. As another example, a polygon-bounded area may be a nature preserve that is not available for deployment of infrastructure.

The polygon-bounded cost data 271 generally contains data relating to the cost of the polygon-bounded area within the polygon-bounded area data 269. As stated, cost is not simply monetary values required to traverse the polygon-bounded area with an alignment. Cost may include other resources required for an alignment to traverse a polygon-bounded area. For example, the cost may include the number of liters of water required to pour concrete within the polygon-bounded area.

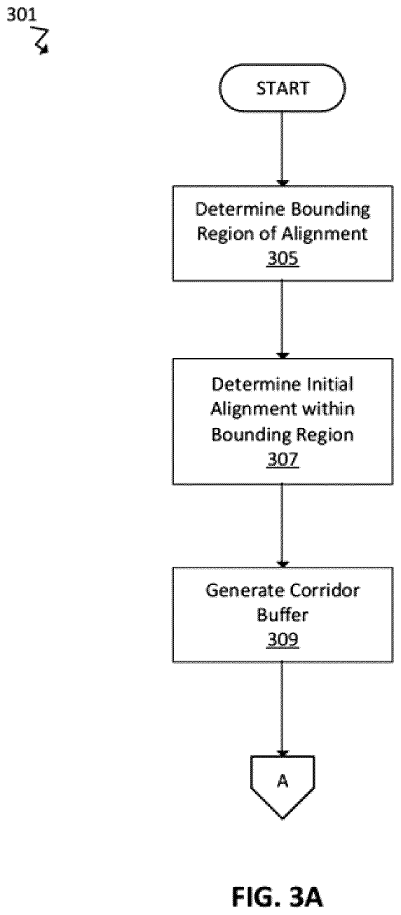

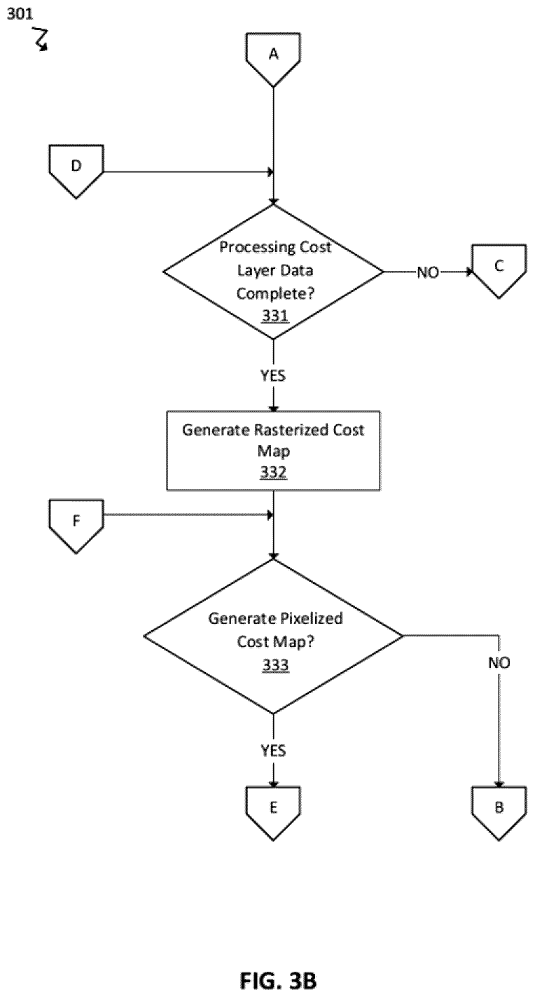

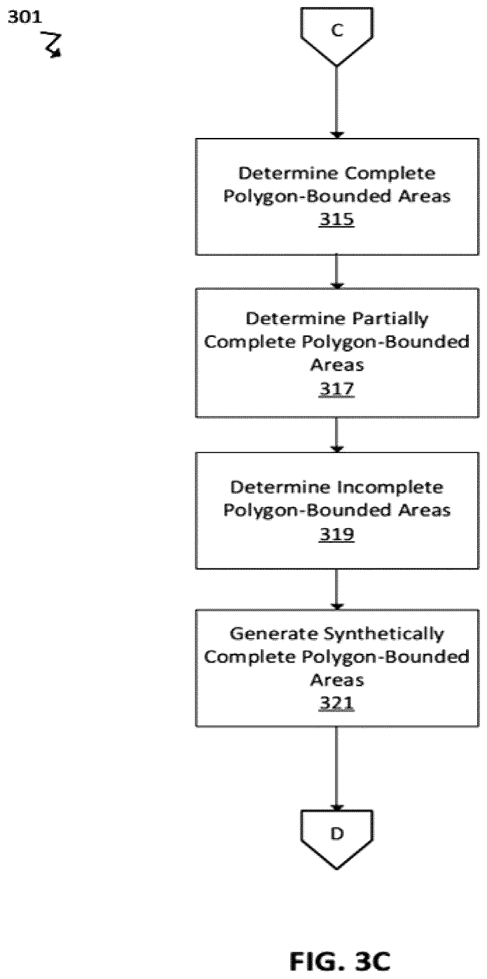

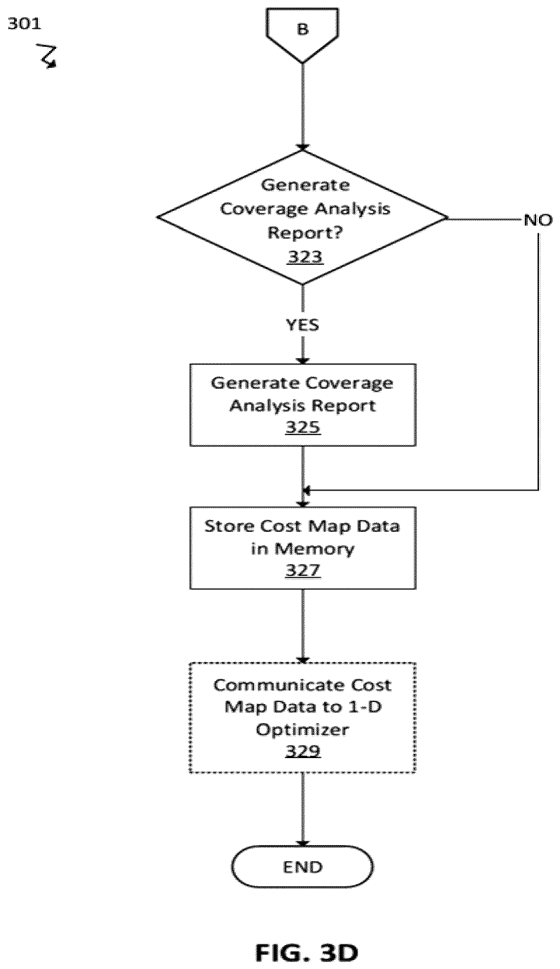

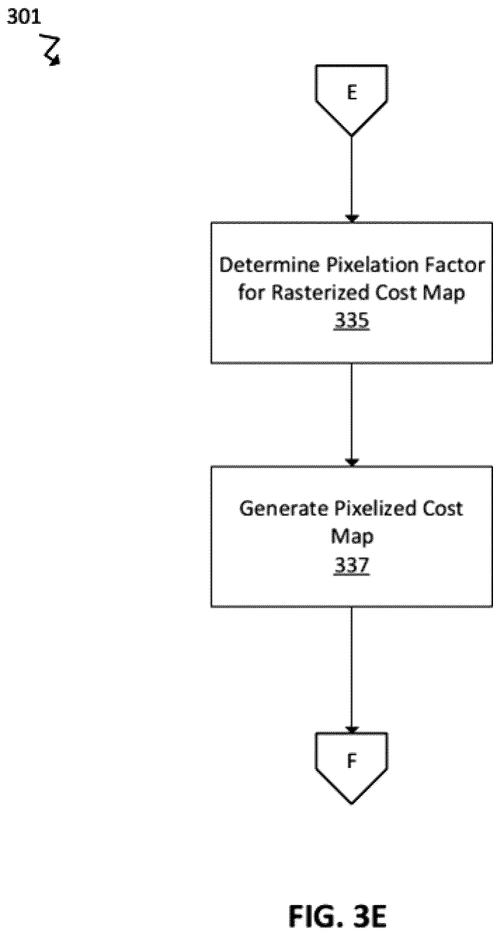

FIG. 3A is a flowchart illustrating a process 301 for geospatial data gap filling, in accordance with various aspects of the present disclosure. The process 301 is generally configured to process various data sources in order for the 1D optimizer 231 to generate an optimized alignment. Specifically, the process 301 may be configured to utilize the cost map data structure 251 and the cost layer data structure 267 in order to generate rasterized cost map data 265. Further, the process 301 is configured to generate pixelized cost map data 266 in order to further reduce and/or eliminate gaps in the processed cost layer data 261 and/or the rasterized cost map data 265. The process 301 begins at the start block and proceeds to block 305.

At the block 305, the process 301 determines the bounding region of the alignment. Any alignment is related to the real-world. As such, the process 301 defines a 2D region upon which the alignment will be deployed. For example, the bounding region may be associated with the boundaries of a state. Therefore, the process 301 defines the outer limits of the search space by setting the bounding region data 253 as the borders of the state. The process 301 then proceeds to block 307.

At the block 307, the process 301 determines the initial alignment within the bounding region. The process 301 sets the alignment data 255 with one or more alignment curves that form an initial alignment within the bounding region (stored in the bounding region data 253). Therefore, the initial alignment may be any alignment conceivable within the bounding region. Such flexibility offers users opportunities to initialize the alignment based on real-world constraints. For example, a human user may be a hyperloop operator deploying a route between the portals 115C, 115D.

In general, the initial alignment is not optimized. Whether generated by human users or automated systems, the initial alignment is a rough estimate of where the alignment will be deployed within the bounding region. Upon further processing, the initial alignment will be optimized by the 1D optimizer 231. The process 301 then proceeds to block 309.

At the block 309, the process 301 generates a corridor buffer. The corridor buffer is associated with the initial alignment. In one aspect, the corridor buffer may be generated by using radii extended from points along the initial alignment. In another aspect, the corridor buffer may be generated by using point distribution. One of skill in the art will appreciate that the corridor buffer may be determined using a number of techniques; however, the corridor buffer should be configured such that the search space for optimizations is smaller than the entire bounding region.

FIG. 3B is a flowchart illustrating the process 301 for geospatial data gap filling, in accordance with various aspects of the present disclosure. The process 301 continues at off-page reference A and proceeds to decision block 331.

At the decision block 331, the process 301 determines whether the processing of cost layer data is complete. If the processing is not complete, the process 301 proceeds along the NO branch to off-page reference C (which continues at FIG. 3C). If the processing is complete, the process 301 proceeds along the YES branch to block 332.

At the block 332, the process 301 generates the rasterized cost map data 265. The rasterized cost map data 265 is a 2D map including a plurality of values associated with costs to traverse. Thus, the rasterized cost map data 265 communicates, to the 1D optimizer 231, the various costs associated with the corridor buffer. For example, an initial alignment may be evaluated based on raw cost layer data 259 that is then transformed into processed cost layer data 261. Once the processed cost layer data 261 is determined, the data layers are combined to form the rasterized cost map data 265. The rasterized cost map data 265 is later used by the 1D optimizer 231 to generate an optimized alignment (e.g., as stored in the alignment data 255). In one aspect, the rasterized cost map data 265 is transformed by the process 301 into pixelized cost map data 266. At block 333, the process 301 determines whether the generate a pixelized cost map. If the pixelized cost map is generated, the process 301 proceeds along the YES branch to reference E. If the pixelized cost map is not generated, the process 301 proceeds along the NO branch to reference D.

Returning to the decision block 331, if the processing of the cost layer data is not complete, the process 301 proceeds along the NO branch to the off-page reference C, as previously stated. One of skill in the art will appreciate that the cost layer data may be either processed cost layer data 261 and/or raw cost layer data 259. Given the potential iterative (or recursive) nature of the process 301, the processed cost layer data 261 may be intermediate and subject to further processing.

One of skill in the art will note that the off-page reference D is positioned before the decision block 331. As such, off-page reference D is utilized to show that the process 301 may iteratively (or recursively) process cost layer data until a completeness is determined and satisfied at the decision block 331. As such, FIG. 3B and FIG. 3C are related.

FIG. 3C is a flowchart illustrating the process 301 for geospatial data gap filling, in accordance with various aspects of the present disclosure. The process 301 continues from the off-page reference C, which originated at FIG. 3B above. The process 301 then proceeds to block 315.

At the block 315, the process 301 determines the completeness of the plurality of polygon-bounded areas. The cost map data structure 251 comprises raw cost layer data 259 that may be complete, partially complete, or wholly incomplete. As such, the process 301 is configured to fill in the data gaps for partially complete and/or incomplete polygon-bounded areas. Table 1A below shows raw cost layer data 259 having at least three cost layer data structures 267 associated with a number of polygon-bounded areas.

TABLE 1A
Example Data for Cost Data Layer Structures Associated
with Polygon-Bounded Areas 415A, 415B, 415D, 415E

| Polygon- | | | | |
|---|---|---|---|---|
| Bounded | | Land | Improvement | Total |
| Area | Polygon Coordinates | Value | Value | Value |
| 415A | A(4.5, 2.7), B(4.82, 2.7), | $150,000 | $72,000 | $222,000 |
| | C(4.76, 2.62), D(4.5, 2.54) | | | |
| 415B | A(4.82, 2.66), B(4.82, 2.7), | $110,000 | $99,000 | NULL |
| | C(5.18, 2.7), D(5.16, 2.42), | | | |
| 415D | A(4.5, 2.54), B(4.76, 2.62), | $0 | $0 | $0 |
| | C(4.78, 2.52), D(4.5, 2.45) | | | |
| 415E | A(4.76, 2.62), B(4.78, 2.64), | $98,000 | $0 | $98,000 |
| | C(4.82, 2.66), D(4.94, 2.52), | | | |
| | E(4.8, 2.46) | | | |

According to one aspect, the data of Table 1A is processed to generate normalized cost data. In a table of polygons, the area of a given polygon is one of the polygon's fundamental key properties that is always present. In one aspect, the cost per square meter or per square kilometer may be considered, depending on the data to be normalized.

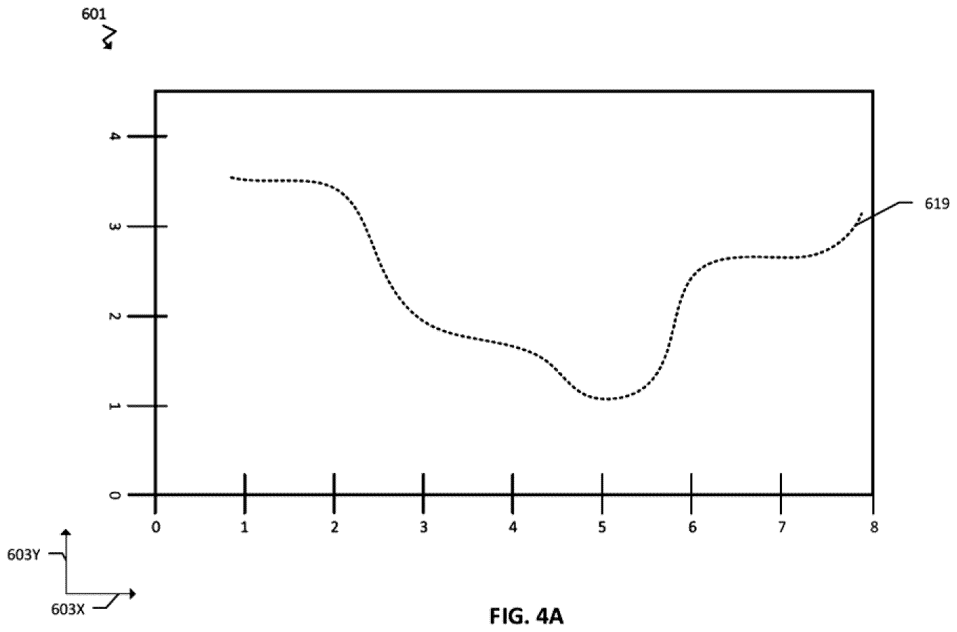

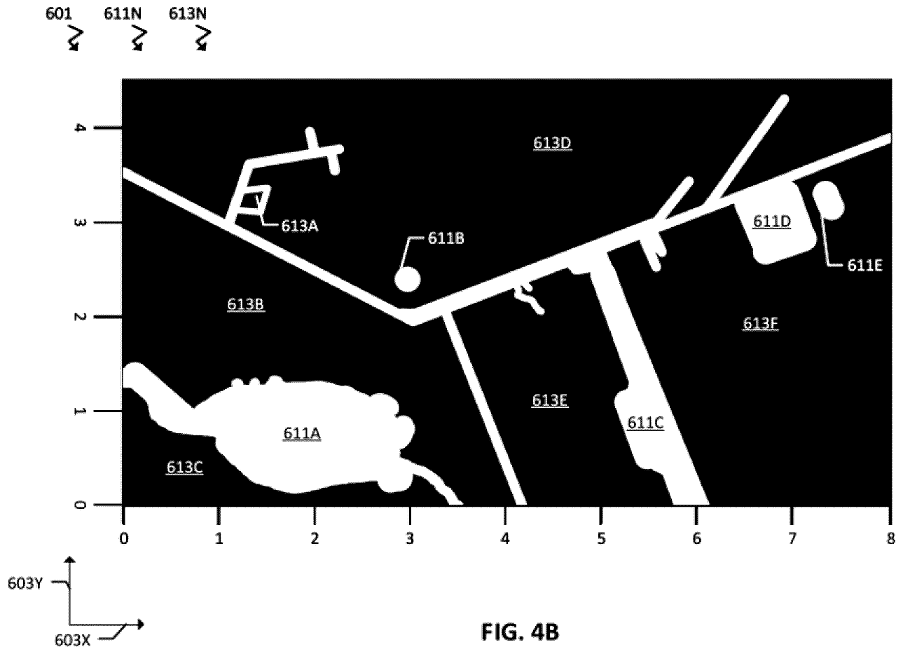

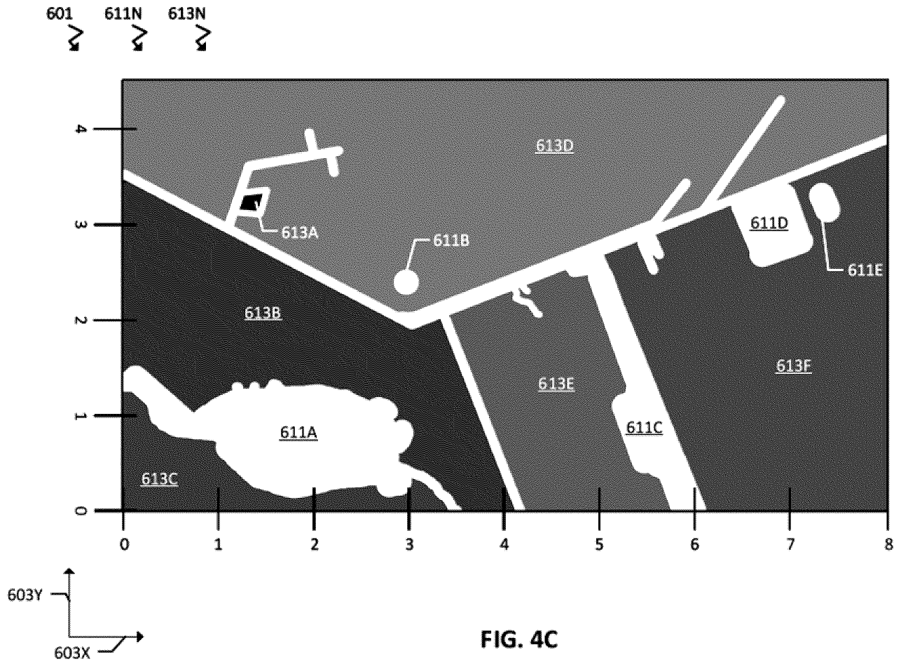

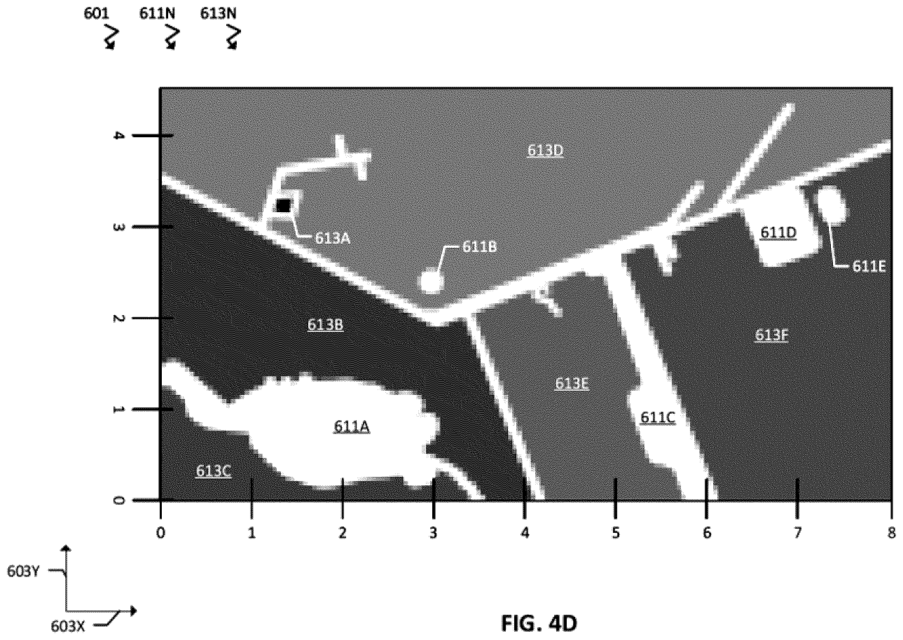

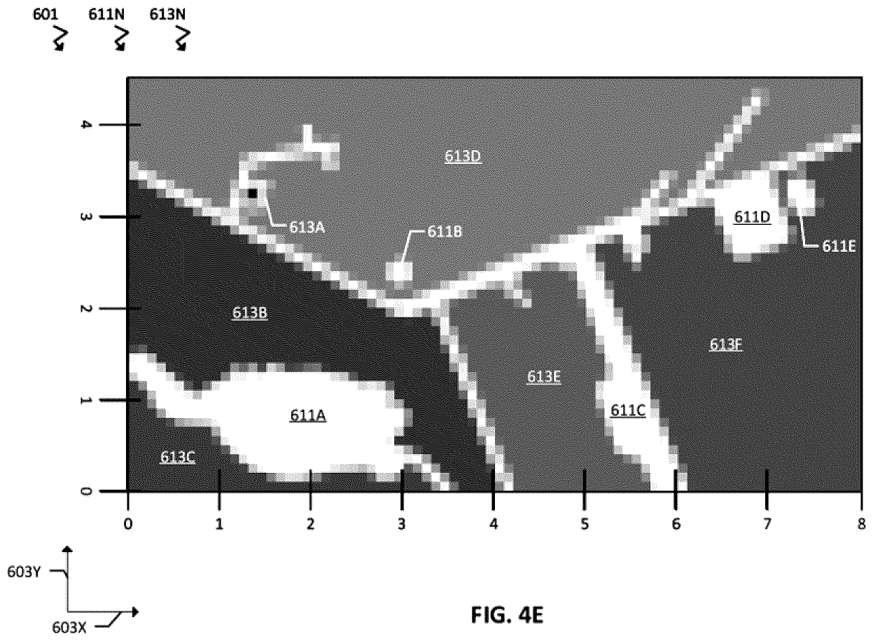

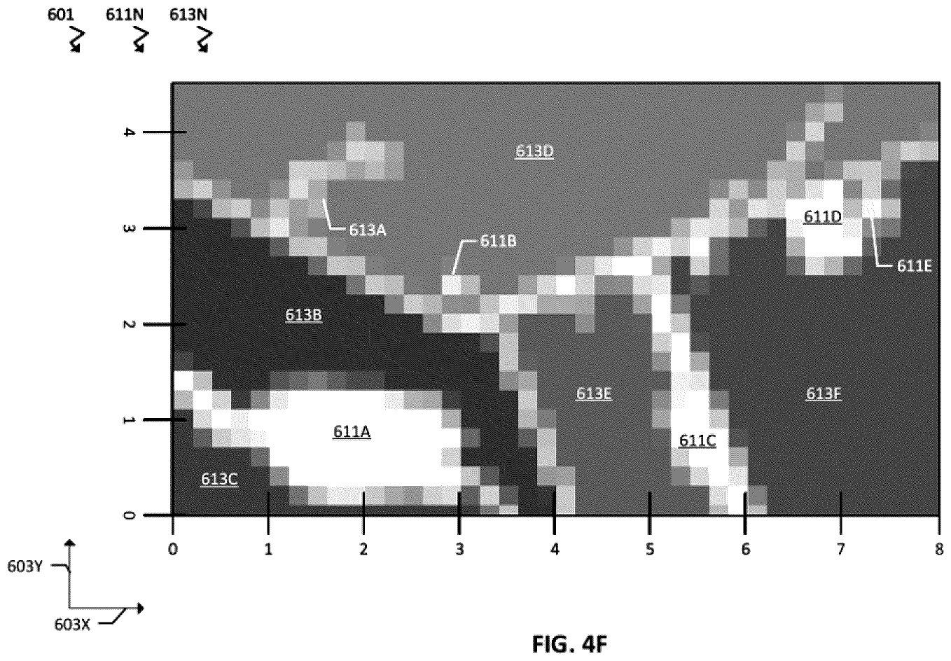

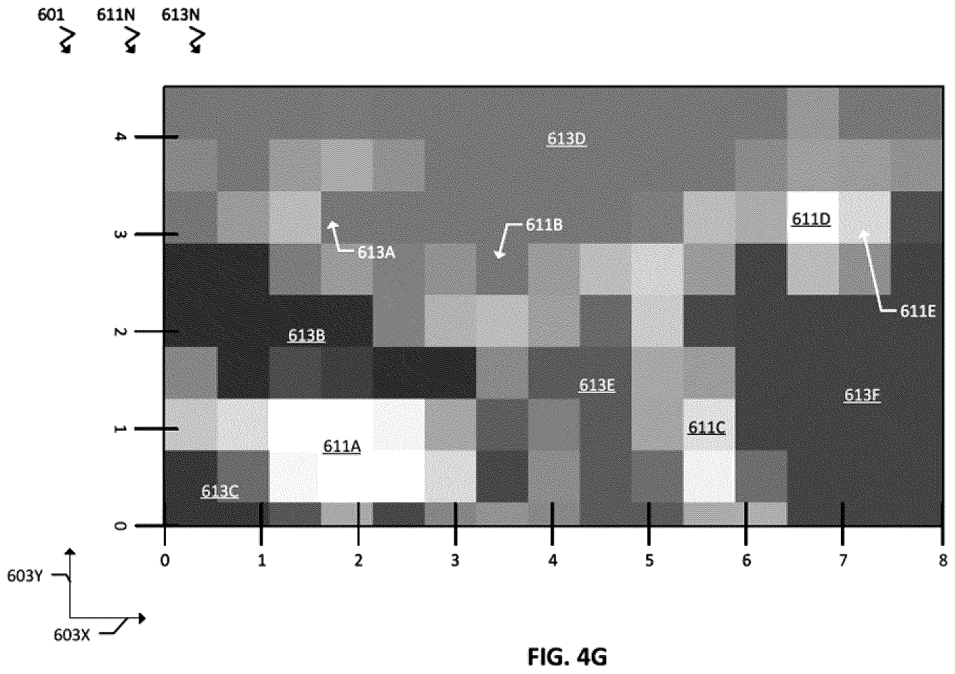

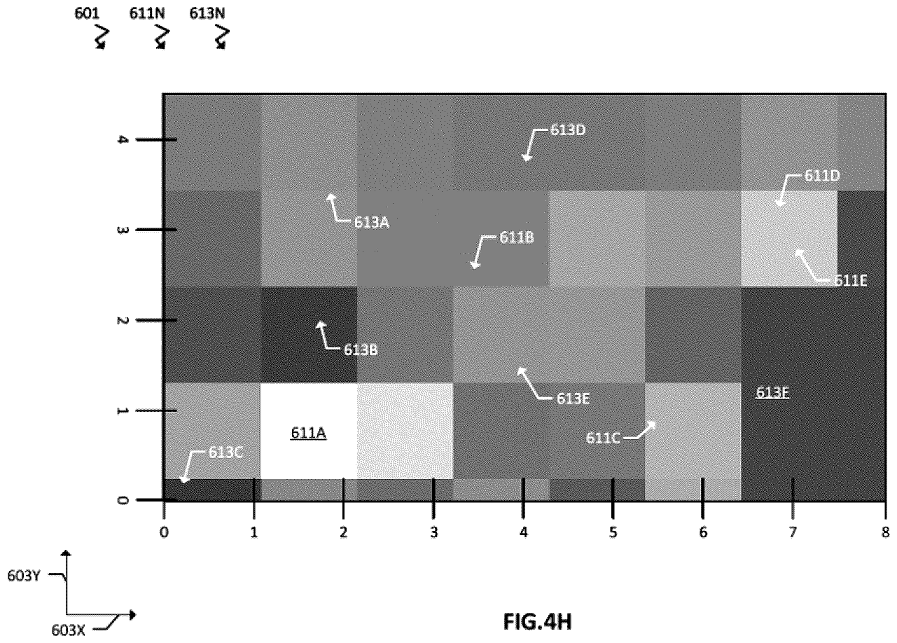

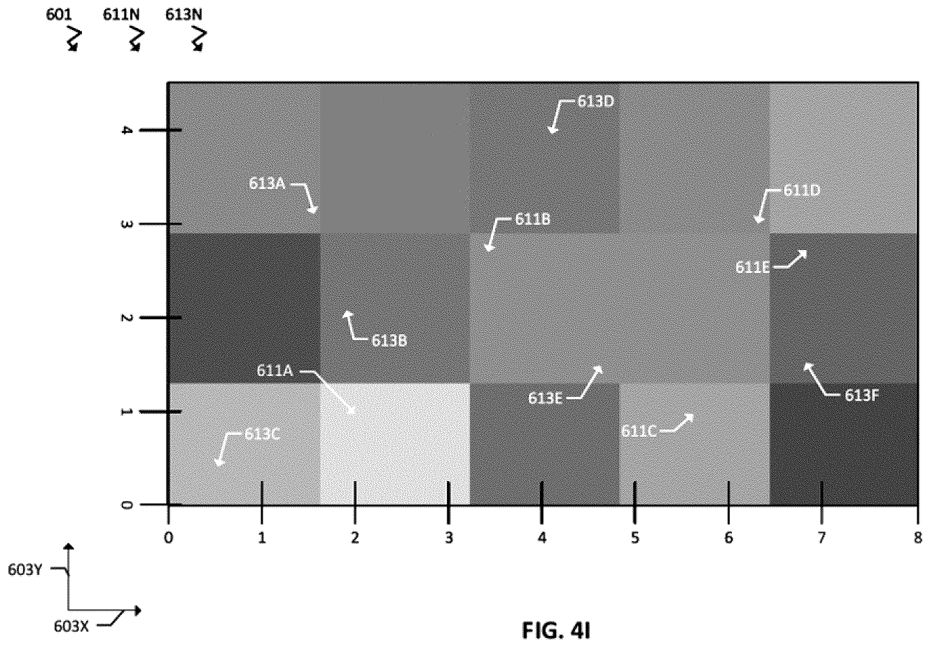

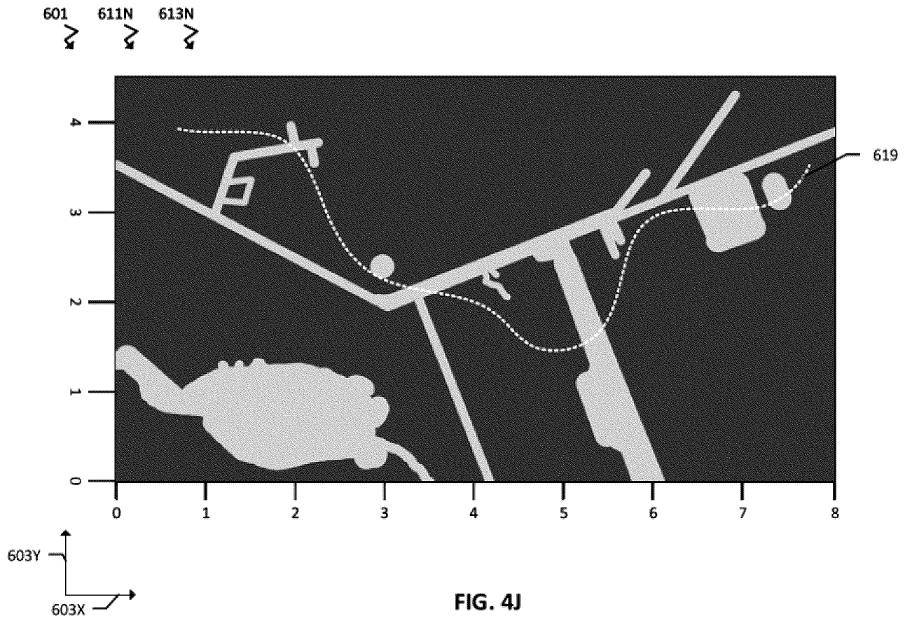

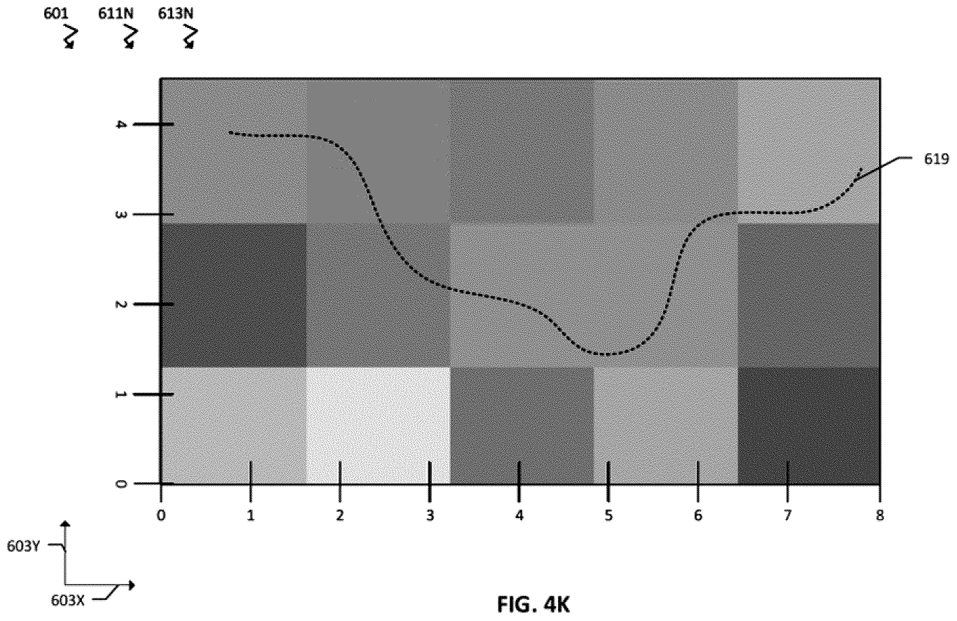

The polygon-bounded areas in Table 1A are associated with four polygon-bounded area 415A, 415B, a 415D, 415E. The polygon-bounded areas 415A, 415B, 415D, 415E are discussed in more detail below at FIG. 4C. For the purposes of the instant example, the polygon-bounded areas 415A, 415B, 415D, 415E are parcels having both land values and improvement values (e.g., buildings). As shown in Table 1A above, the total land value is the summation of the land value and the improvement value.

In one aspect, the values of Table 1A may be associated with an instance of the cost layer data structure 267. Further, the polygon coordinates may be stored in an instance of the polygon-bounded area data 269. Still further, the land value and the improvement value may be stored in the polygon-bounded cost data 271. As such, the cost layer data structure 267 may store the data of Table 1A in the raw cost layer data 259. However, the processed cost layer data 261 is uninitialized because the process 301 has not determined the existing completeness or started the operations of reaching full and/or synthetic completeness.

In general, the GIS data may be incomplete, partially complete, or complete. As shown in Table 1A, the polygon-bounded area 415A is fully complete. Further, the 415B, 415D, 415E are partially complete. The process 301 then proceeds to block 317.

At the block 317, the process 301 determines the partial completeness of the plurality of polygon-bounded areas. As shown in Table 1A, the polygon-bounded areas 415B, 415E are partially complete. The process 301 then proceeds to block 319.

At the block 319, the process 301 determines the incompleteness of the plurality of polygon-bounded areas. As shown in Table 1A, the polygon-bounded area 415D is incomplete. The process 301 then proceeds to block 321.

At the block 321, the process 301 generates synthetic completeness of the plurality of polygon-bounded areas. The process 301 then proceeds to the off-page reference D which continues at FIG. 3B, as previously stated. One of skill in the art will appreciate that the process 301 may iteratively (or recursively) determine the states of the plurality of polygon-bounded areas. Further, the process 301 may leverage previous determinations and operations to inform current determinations of completeness as well as generate synthetic completeness of the plurality of polygon-bounded areas.

FIG. 3D is a flowchart illustrating the process 301 for geospatial data gap filling, in accordance with various aspects of the present disclosure. The process 301 continues from off-page reference B, which originated at FIG. 3B above. The process 301 proceeds to the decision block 323.

At the decision block 323, the process 301 determines whether the coverage analysis report 225 should be generated. In one aspect, the coverage analysis report 225 may be displayed on a user terminal for stakeholders to evaluate results of the process 301. If it is determined that the coverage analysis report 225 should not be generated, the process 301 proceeds along the NO branch to block 327. If it is determined that the coverage analysis report 225 should be generated, the process 301 proceeds along the YES branch to block 325.

At the block 325, the process 301 generates the coverage analysis report 225. The coverage analysis report 225 is of particular use to human users because the coverage analysis report 225 may be formatted as human-readable. Thus, the human user may then review the operations and results of the process 301. The process 301 then proceeds to block 327.

At the block 327, the process 301 stores the any cost maps in memory. For instance, if the process 301, at the block 332, generates rasterized cost map data 265, then the rasterized cost map data 265 will be stored in memory. Similarly, if the operations at the decision block 333 lead to the generation of a pixelized cost map data 266, then the pixelized cost map data 266 will be stored in the memory. The process 301 then proceeds to block 329.

At optional block 329, the process 301 communicates the rasterized cost map data 265 and/or the pixelized cost map data 266 to the 1D optimizer 231. The 1D optimizer 231 will then perform optimizations based on the rasterized cost map data 265 in order to generate an optimized instance of the alignment data 255. The process 301 then proceeds to the end block and terminates.

FIG. 3E is a flowchart illustrating the process 301 for geospatial data gap filling, in accordance with various aspects of the present disclosure. The process 301 begins at the off-page reference E (from FIG. 3B above). The process 301 then proceeds to block 335.

At the block 335, the process 301 determines the pixelization factor for the rasterized cost map data 265. At a high level, the rasterized cost map data 265 contains a 2D array comprising values related to the cost to traverse when using the 1D optimizer 231. The pixelization factoring data 263 stores the pixelization factoring value and any related metadata. The pixelization factoring value may be a scalar value, whereas the related metadata may be various in nature.

Metadata may include additional information relating to the bounding boxes of each pixelization region. For example, if a 1,000 px by 1,000 px rasterized cost map has bounding boxes of 10 px by 10 px, then 100 bounding boxes may be defined in the pixelization factoring metadata. One or more offset values may be associated with a particular bounding box. The process 301 then proceeds to block 337.

At the block 337, the process 301 performs pixelization on the rasterized cost map data 265. The pixelization factoring data 263 and the rasterized cost map data 265 are processed to generate a pixelized instance of the rasterized cost map data 265—being eventually stored as pixelized cost map data 266.

The process 301 then proceeds to the off-page reference F. One of skill in the art will appreciate that the off-page reference F is also shown at FIG. 3B in order to demonstrate the iterative (and/or recursive) nature of the process 301 with respect to the pixelation operations (e.g., as shown in blocks 335, 337, above). Thus, the pixelization performed may result in a number of intermediate rasterized cost maps that each contain pixelized-enhanced representations of input data (e.g., for the 1D optimizer 231).

FIG. 4A is a block diagram illustrating a bounding region 601, in accordance with various aspects of the present disclosure. The example of FIG. 4A is a top-down view of the bounding region 601. The bounding region 601 is generally an area of land in which a linear infrastructure alignment may be deployed. The entire bounding region 601 is shown as a blank space to denote that no data has been mapped to the bounding region 601. As will be shown, data (e.g., GIS data) may be associated with the bounding region 601 to provide both designers and optimizers (e.g., the 1D optimizer 231) the capabilities to design and optimize an alignment (e.g., as stored in alignment data 255).

A first axis 603X and a second axis 603Y are shown. The axes 603X, 603Y are associated with a plurality of reference numbers along the x-axis and the y-axis of the bounding region 601. One of skill in the art will appreciate that the references denoted may be any type of coordinate system (e.g., one relating to latitude/longitude coordinates).

As shown in the instant view, an alignment curve 619 is deployed in the bounding region 601. The alignment curve 619 is an initial alignment that has not been optimized. In one aspect, the alignment curve 619 is human-generated. In another aspect, the alignment curve 619 is machine-generated (e.g., using an AI technique). One of skill in the art will appreciate that the alignment curve 619 is likely not sufficient for real-world deployment since no GIS data is associated with the bounding region 601.

FIG. 4B is a block diagram illustrating the bounding region 601, in accordance with various aspects of the present disclosure. The bounding region 601 is shown as being augmented by additional GIS data. References shall be made to a number of data regions and data gaps. The data regions are generally those areas in which GIS data exists. On the other hand, the data gaps are, as the name implies, gaps in the GIS data.

The bounding region 601 contains a plurality of data gaps 611N and a plurality of data regions 613N. The plurality of data gaps 611N comprises a first data gap 611A, a second data gap 611B, a third data gap 611C, and a fourth data gap 611D. The plurality of data regions 613N comprises a first data region 613A, a second data region 613B, a third data region 613C, a fourth data region 613D, a fifth data region 613E, and a sixth data region 613F. The plurality of data regions 613N and the plurality of data gaps 611N are related because the plurality of data regions 613N have gaps in the data, hence the plurality of data gaps 611N appear.

As shown, the bounding region 601 is represented in black and white to indicate that one single data layer is being presented as processed cost layer data 261. In the instant view, the black denotes availability of any data whereas the white denotes areas completely lacking data. To be clear, the plurality of data gaps 611N (as shown in white) are not necessarily impossible to traverse. Rather, the cost is simply unknown. The data gap 611C appears to be a street which should, in all likelihood, be available as a right-of-way or for purchase. However, such an inference may or may not be correct. Alternatively, the data gap 611C may represent a wildlife refuge corridor. Thus, the data gap 611C is stored by the process 301 as simply that—a gap in the data. Such treatment enables subsequent pixelization operations to synthetize data within the plurality of data gaps 611N.

The plurality of data regions 613N generally includes areas where at least some data exists. For example, the data region 613E has data sufficient to be separated from the data regions 613B, 613D, 613F, thus forming the data gap 611C. The process 301 is configured to augment the bounding region data 253 with additional layers. For example, the process 301 may add an additional cost layer data structure 267, that is associated with the raw cost layer data 259.

The data gap 611A is key to note as the data gap 611A is relatively larger than other data gaps (e.g., the data gap 611B). As such, the data gap 611A will require coarser pixelation factors in order to be substantially reduced and/or completely eliminated. In contrast, the data gap 611B is relatively smaller and will conversely require finer pixelation factors than required by the data gap 611A. The data gaps 611D, 611E provide intermediate sizes of data gaps in order to similarly demonstrate the effect of pixelization of the bounding region 601.

One of skill in the art will appreciate that the pixelization factor value in the instant view may be selected from many values; as such, the pixelization factors disclosed below are illustrative and not exhaustive.

FIG. 4C is a block diagram illustrating the bounding region 601, in accordance with various aspects of the present disclosure. As shown, the plurality of data regions 613N is shown with varying shades to indicate an additional cost layer data structure 267 is augmenting the data disclosed at FIG. 4B, above. As such, the plurality of data regions 613N has distinct values distributed. One of skill in the art will appreciate that the plurality of data gaps 611N remains unchanged, e.g., the white areas in the bounding region 601 persist.

At this point in time, the process 301 is performing the operations associated with the blocks 315, 317, 319, 321 and the decision block 331. The operations are configured to eventually converge by creating rasterized cost map data 265, e.g., at the block 332. One of skill in the art will appreciate that additional cost layer data structures may be combined with the data shown in the instant view.

FIG. 4D is a block diagram illustrating the bounding region 601, in accordance with various aspects of the present disclosure. The process 301 has increased the pixelization factor to two. One of skill in the art will appreciate that rectangles may be used in lieu of squares. As shown, the plurality of data gaps 611N is substantially unchanged. Therefore, a higher (coarser) pixelation factor may be required to address the plurality of data gaps 611N.

FIG. 4E is a block diagram illustrating the bounding region 601, in accordance with various aspects of the present disclosure. The pixelation factor shown is three (e.g., as represented in the pixelization factoring data 263). As shown, the data gap 611B is substantially reduced; however, a small data gap in the center of the data gap 611B remains.

FIG. 4F is a block diagram illustrating the bounding region 601, in accordance with various aspects of the present disclosure. The pixelization factor shown in four. As shown, the plurality of data gaps 611A is shrinking in coverage of the bounding region 601. The data gap 611B is further reduced in size. Likewise, the data gap 611E is further reduced in size. One of skill in the art will appreciate how the data gap 611C has been greatly improved. The segment spanning from (0, 3.5) to (8, 3.5) contains very few data gap regions. As such, the 1D optimizer 231 is capable of better optimization of the alignment curve 619.

However, the data gap 611A, while improved, is still large and may require a higher (coarser) pixelization factor. Likewise, the data gap 611D is noticeable and may be improved using a higher (coarser) pixelization factor.

FIG. 4G is a block diagram illustrating the bounding region 601, in accordance with various aspects of the present disclosure. The pixelization factor value is five. The data gaps 611B, 611C, 611E are eliminated. The data gaps 611A, 611D still remain visible. However, the data gap 611D is substantially eliminated. The data gap 611A still persists and may require further increases in the pixelization factor value.

FIG. 4H is a block diagram illustrating the bounding region 601, in accordance with various aspects of the present disclosure. The pixelization factor value is six. The data gaps 611B, 611C, 611D, 611E are completely eliminated. Only the data gap 611A persists. One of skill in the art will appreciate that the data gap 611A began as the largest data gap in the bounding region 601.

FIG. 4I is a block diagram illustrating the bounding region 601, in accordance with various aspects of the present disclosure. The pixelization factor value is seven. The plurality of data gaps 611N are completely eliminated from the representation of the bounding region 601 shown in the instant view. One of skill in the art will appreciate that the finer pixelization factors were insufficient for the data gap 611A but were adequate for smaller-sized gaps such as 611B.

FIG. 4J is a block diagram illustrating the bounding region 601, in accordance with various aspects of the present disclosure. The instant view is a reproduction of the view shown in FIG. 4B with fewer labels to highlight the alignment curve 619 traversing data gaps (e.g., the data gap 611C). Further, the instant view is shaded such that the alignment curve 619 is clearer to the reader.

FIG. 4K is a block diagram illustrating the bounding region 601, in accordance with various aspects of the present disclosure. The instant view is a reproduction of the view shown in FIG. 4I with fewer labels. As shown, the alignment curve 619 no longer traverses data gaps (e.g., as shown in FIG. 4J, inter alia). Rather, the alignment curve 619 now traverses the bounding region 601 with adequate data for subsequent optimizations (e.g., as those performed by the 1D optimizer 231). In some examples, the alignment curve 619 may be re-aligned based on the cost data associated with the pixelized bounding region 601 shown in the example of FIG. 4K. A model (e.g., machine learning model) may perform the re-alignment.

FIG. 5 is a block diagram illustrating a computing device 700, in accordance with various aspects of the present disclosure. The computing device 700 may be configured to store and execute the GIS management system 201, the cost map data structure 251, the cost layer data structure 267, and the process 301.

The computing device 700 may include a processor 711 (e.g., an ARM processor) coupled to volatile memory 712 (e.g., DRAM) and a large capacity nonvolatile memory 713 (e.g., a flash device). Additionally, the computing device 700 may have one or more antenna 708 for sending and receiving electromagnetic radiation that may be connected to a wireless data link and/or cellular telephone transceiver 716 coupled to the processor 711. The computing device 700 may also include an optical drive 714 and/or a removable disk drive 715 (e.g., removable flash memory) coupled to the processor 711. The computing device 700 is not limited to one processor 711, multiple processors 711 may be use by the computing device 700.

The computing device 700 may include a touchpad touch surface 717 that serves as the computing device's 700 pointing device, and thus may receive drag, scroll, flick etc. gestures similar to those implemented on computing devices equipped with a touch screen display (not shown). In one aspect, the touchpad touch surface 717 may be integrated into one of the computing device's 700 components (e.g., a display 719). In one aspect, the computing device 700 may include a keyboard 718 which is operable to accept user input via one or more keys within the keyboard 718. In one configuration, the computing device's 700 housing includes the touchpad touch surface 717, the keyboard 718, and the display 719 all coupled to the processor 711. Other configurations of the computing device 700 may include a computer mouse coupled to the processor (e.g., via a USB input) as are well known, which may also be used in conjunction with the various aspects described.

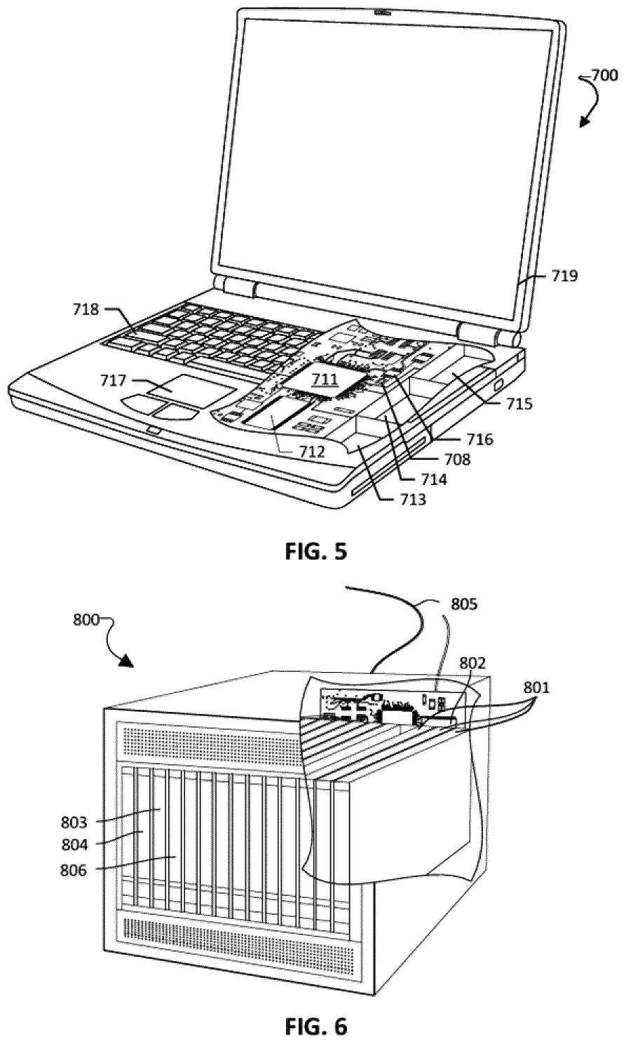

FIG. 6 is a block diagram illustrating a server 800, in accordance with various aspects of the present disclosure. The server 800 may function as a standalone unit or work in conjunction with the computing device 700 to store and execute the GIS management system 201, the cost map data structure 251, the cost layer data structure 267, and the process 301.

The server 800 may include one or more processor assemblies 801 (e.g., an x86 processor) coupled to volatile memory 802 (e.g., DRAM) and a large capacity nonvolatile memory 804 (e.g., a magnetic disk drive, a flash disk drive, etc.). As illustrated in instant figure, processor assemblies 801 may be added to the server 800 by insertion into the racks of the assembly. The server 800 may also include an optical drive 806 coupled to the processor assemblies 801. The server 800 may also include a network access interface 803 (e.g., an ethernet card, WIFI card, etc.) coupled to the processor assemblies 801 for establishing network interface connections with a network 805. The network 805 may be a local area network, the Internet, a public switched telephone network, and/or a cellular data network (e.g., LTE, 5G, etc.).

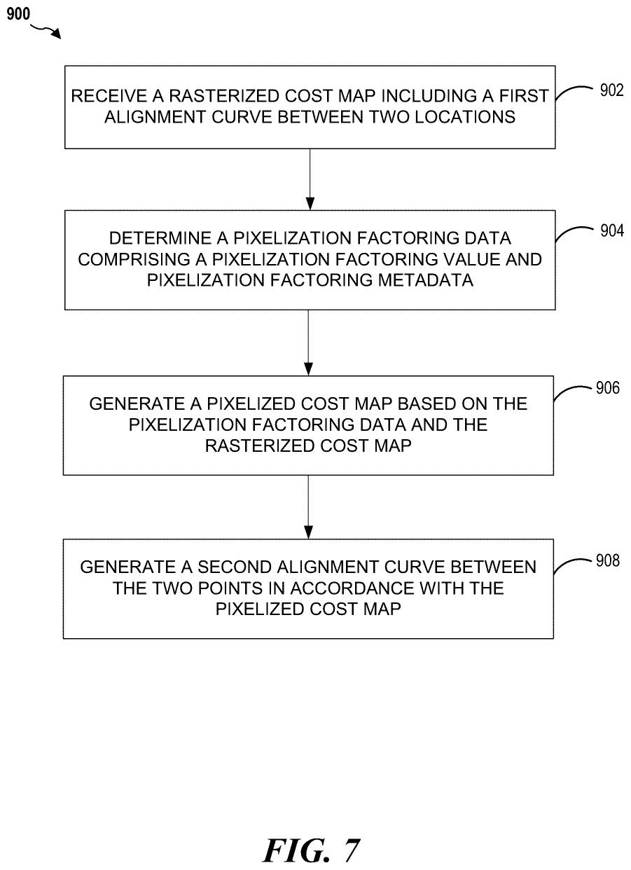

FIG. 7 is a flow diagram illustrating an example of a process 900 for gap filling of geographic information service (“GIS”) data, in accordance with various aspects of the present disclosure. In some examples, the process 900 may be performed by the one or more components of the server 800 and/or the computing device 700. As shown in the example of FIG. 7, at block 902, the process 900 begins by receiving a rasterized cost map including a first alignment curve between two locations. At block 904, the process 900 determines a pixelization factoring data comprising a pixelization factoring value and pixelization factoring metadata. At block 906, the process 900 generating a pixelized cost map based on the pixelization factoring data and the rasterized cost map. Finally, at block 908 the process 900 generates a second alignment curve between the two points in accordance with the pixelized cost map.

The foregoing method descriptions and diagrams/figures are provided merely as illustrative examples and are not intended to require or imply that the operations of various aspects must be performed in the order presented. As will be appreciated by one of skill in the art, the order of operations in the aspects described may be performed in any order. Words such as “thereafter,” “then,” “next,” etc. are not intended to limit the order of the operations; such words are used to guide the reader through the description of the methods and systems described. Further, any reference to claim elements in the singular, for example, using the articles “a,” “an,” or “the” is not to be construed as limiting the element to the singular.

Various illustrative logical blocks, modules, components, circuits, and algorithm operations described in connection with the aspects described may be implemented as electronic hardware, computer software, or combinations of both. To clearly illustrate this interchangeability of hardware and software, various illustrative components, blocks, modules, circuits, operations, etc. have been described generally in terms of their functionality. Whether such functionality is implemented as hardware or software depends upon the particular application and design constraints imposed on the overall system. One of skill in the art may implement the described functionality in varying ways for each particular application, but such implementation decisions should not be interpreted as causing a departure from the scope of the claims.

The hardware used to implement various illustrative logics, logical blocks, modules, components, circuits, etc. described in connection with the aspects described may be implemented or performed with a general purpose processor, a digital signal processor (“DSP”), an application specific integrated circuit (“ASIC”), a field programmable gate array (“FPGA”) or other programmable logic device, discrete gate logic, transistor logic, discrete hardware components, or any combination thereof designed to perform the functions described. A general-purpose processor may be a microprocessor, a controller, a microcontroller, a state machine, etc. A processor may also be implemented as a combination of receiver smart objects, e.g., a combination of a DSP and a microprocessor, a plurality of microprocessors, one or more microprocessors in conjunction with a DSP core, or any other such like configuration. Alternatively, some operations or methods may be performed by circuitry that is specific to a given function.

In one or more aspects, the functions described may be implemented in hardware, software, firmware, or any combination thereof. If implemented in software, the functions may be stored as one or more instructions (or code) on a non-transitory computer-readable storage medium or a non-transitory processor-readable storage medium. The operations of a method or algorithm disclosed may be embodied in a processor-executable software module or as processor-executable instructions, both of which may reside on a non-transitory computer-readable or processor-readable storage medium. Non-transitory computer-readable or processor-readable storage media may be any storage media that may be accessed by a computer or a processor (e.g., RAM, flash, etc.). By way of example but not limitation, such non-transitory computer-readable or processor-readable storage media may include RAM, ROM, EEPROM, NAND FLASH, NOR FLASH, M-RAM, P-RAM, R-RAM, CD-ROM, DVD, magnetic disk storage, magnetic storage smart objects, or any other medium that may be used to store program code in the form of instructions or data structures and that may be accessed by a computer. Disk as used may refer to magnetic or non-magnetic storage operable to store instructions or code. Disc refers to any optical disc operable to store instructions or code. Combinations of any of the above are also included within the scope of non-transitory computer-readable and processor-readable media. Additionally, the operations of a method or algorithm may reside as one or any combination or set of codes and/or instructions on a non-transitory processor-readable storage medium and/or computer-readable storage medium, which may be incorporated into a computer program product.

The preceding description of the disclosed aspects is provided to enable any person skilled in the art to make, implement, or use the claims. Various modifications to these aspects will be readily apparent to those skilled in the art, and the generic principles defined may be applied to other aspects without departing from the scope of the claims. Thus, the present disclosure is not intended to be limited to the aspects illustrated but is to be accorded the widest scope consistent with the claims disclosed.

1. A method for gap filling of geographic information service (“GIS”) data, comprising:
receiving a rasterized cost map including a first alignment curve between two locations;
determining a pixelization factoring data comprising a pixelization factoring value and pixelization factoring metadata;
generating a pixelized cost map based on the pixelization factoring data and the rasterized cost map; and
generating a second alignment curve between the two points in accordance with the pixelized cost map.

2. The method of claim 1, wherein the rasterized cost map data includes one or more data gaps, each of the data gaps is associated with a location having a value in the pixelized cost map.

3. The method of claim 1, wherein each of the one or more data gaps is associated with a respective location that is not associated with cost data.

4. The method of claim 1, wherein the pixelized cost map does not include the one or more data gaps.

5. The method of claim 1, wherein the pixelization factoring metadata comprises bounding box data and/or bounding box offset data.

6. The method of claim 1, wherein generating the second alignment curve comprises re-aligning the first alignment curve based on cost data associated with the pixelized cost map.

7. The method of claim 6, wherein the first alignment curve is re-aligned via a machine learning model.

8. An apparatus for gap filling of geographic information service (“GIS”) data, comprising:
one or more processors; and
one or more memories coupled with the one or more processors and storing processor-executable code that, when executed by the one or more processors, is configured to cause the apparatus to:
receive a rasterized cost map including a first alignment curve between two locations;
determine a pixelization factoring data comprising a pixelization factoring value and pixelization factoring metadata;
generate a pixelized cost map based on the pixelization factoring data and the rasterized cost map; and
generate a second alignment curve between the two points in accordance with the pixelized cost map.

9. The apparatus of claim 8, wherein the rasterized cost map data includes one or more data gaps, each of the data gaps is associated with a location having a value in the pixelized cost map.

10. The apparatus of claim 8, wherein each of the one or more data gaps is associated with a respective location that is not associated with cost data.

11. The apparatus of claim 8, wherein the pixelized cost map does not include the one or more data gaps.

12. The apparatus of claim 8, wherein the pixelization factoring metadata comprises bounding box data and/or bounding box offset data.

13. The apparatus of claim 8, wherein execution of the processor-executable code that causes the apparatus to generate the second alignment curve further causes the apparatus to re-align the first alignment curve based on cost data associated with the pixelized cost map.

14. The apparatus of claim 13, wherein the first alignment curve is re-aligned via a machine learning model.

15. A non-transitory computer-readable medium having program code recorded thereon for gap filling of geographic information service (“GIS”) data, the program code executed by one or more processors and comprising:
program code to receive a rasterized cost map including a first alignment curve between two locations;
program code to determine a pixelization factoring data comprising a pixelization factoring value and pixelization factoring metadata;
program code to generate a pixelized cost map based on the pixelization factoring data and the rasterized cost map; and
program code to generate a second alignment curve between the two points in accordance with the pixelized cost map.

16. The non-transitory computer-readable medium of claim 15, wherein the rasterized cost map data includes one or more data gaps, each of the data gaps is associated with a location having a value in the pixelized cost map.

17. The non-transitory computer-readable medium of claim 15, wherein each of the one or more data gaps is associated with a respective location that is not associated with cost data.

18. The non-transitory computer-readable medium of claim 15, wherein the pixelized cost map does not include the one or more data gaps.

19. The non-transitory computer-readable medium of claim 15, wherein the pixelization factoring metadata comprises bounding box data and/or bounding box offset data.

20. The non-transitory computer-readable medium of claim 15, wherein the program code to generate the second alignment curve further comprises program code to re-align the first alignment curve based on cost data associated with the pixelized cost map.
